(19) United States
(12) Patent Application Publication
(10) Pub. No.: US 2005/0018444 A1
(43) Pub. Date: Jan. 27, 2005

(54) Illuminated hazard warning light

(76) Inventor: Larry R. Todd, Cleveland (GB)

Correspondence Address: Obermayer, Rebmann, Maxwell & Hippel, LLP;One Penn Center, 19th Floor, 1617 John F. Kennedy Blvd., Philadelphia, PA, 19103-1895, US

(21) Appl. No.: 10/625,502

(22) Filed: Jul. 23, 2003

(51) Int. Cl. F21V 21/00; B60Q 1/26

(52) U.S. Cl. 362/545; 362/540

(57) ABSTRACT

An illuminated hazard warning light is disclosed. The illuminated hazard warning light includes a substantially flat hollow triangular casing. A plurality of light emitting diodes is housed within the hollow triangular casing. A connection device, electrically connects the plurality of diodes to an electrical power source.

### FIELD OF THE INVENTION

The present invention relates to illuminated hazard warning lights, and in particular to illuminated hazard warning lights on vehicles.

### BACKGROUND OF THE INVENTION

A dangerous condition can often arise when a vehicle is stopped on the side of a road, especially in an emergency. In order to avoid the situation becoming even more dangerous, it is helpful if some method of warning an oncoming driver that a vehicle is stopped along the side of the road is employed, and an illuminated device is more readily seen than one that is not illuminated. Most vehicles are equipped with hazard warning lights, but these lights are a significant drain on the vehicle's battery, and are often located at a lower position on the vehicle than might be readily seen. Warning triangles provide a better indicator to an oncoming driver of a stationary vehicle in trouble, but typically these triangles are placed on the road behind a vehicle and are subject to being knocked over or removed.

U.S. Pat. No. 4,631,516 discloses an auxiliary alarm system can be mounted at eye level on a trunk lid or the like or can be seated on or secured to a vehicle rear window shelf for viewing by a trailing vehicle driver, pedestrians, cyclists, etc. The system includes a housing containing a display window with a visual warning display device, such as a bulb-lighted printed sheet, or an L.E.D. array mounted therein to provide a traveling message and activatable through an electrical circuit connected to the vehicle rear brake light or turn signal circuit. The housing can include a timer and battery to prolong the display, once it is activated by the rear brake light circuit and/or a sensor-discriminator to select one of a number of visual warning displays in response to multiple brake pedal or turn signal circuit activations. An audible alarm can also be connected in the housing. The housing can further include a radio signal or radar signal activatable switch and battery to activate the visual display device upon receipt of a radio or radar signal. The system is compact, inexpensive, easily installed and needs no complicated wiring.

U.S. Pat. No. 5,764,141 is directed to a motor vehicle warning signal light assembly installed within a car and near a back window, which includes stop signal light, an invertedly disposed V-shaped signal light, a control switch, a leftward turn signal light, and a rightward turn signal light. The stop signal light is synchronously operated with the stop lights of the motor vehicle. The invertedly disposed V-shaped signal light and the stop signal light form a triangle signal light, which can be manually turned on by the control switch. The leftward turn signal light and the rightward turn signal light of the assembly are respectively operated with the leftward turn signal light and rightward turn signal light of the motor vehicle.

U.S. Pat. No. 6,304,174 discloses an emergency auto visual communication system that will enhance roadway, vehicular, and individual safety. A stranded motorist, accident victim, medical emergency, etc. is provided a viable means for communication of the situation to a casual observer, or proper authorities, precisely, and rapidly without having to leave the safety and confines of the vehicle. That is, the invention provides an advantageous means to prevent loss of life, save precious seconds, and provide the individual in need the proper help by use of the illuminated electronic message board attached to the rear window of a vehicle controlled by an alpha-numeric computer keyboard.

Additionally, U.S. Pat. No. 5,400,225 is directed to an optical fiber illumination device is disclosed. The optical fiber illumination device includes at least one optical fiber cable, one or more light sources for introducing light into the optical fiber cable, a lens through which light from each light source passes prior to entering the optical fiber cable for producing a colored light, electrical circuitry for energizing the light source, and a housing for containing the circuitry and the light source. A first light source is energized by a first power source. Light emitted from the first light source passes through a first lens which possesses a desire filtering characteristic. Upon application of the second power source, a first control device disable the first light source. Moreover, the second power source may energize a second light source which passes through a second lens having a filtering characteristic distinct from that of the first lens. Upon application of a third power source, a second control device disables the first control device.

U.S. Pat. No. 5,255,164 discloses a motor vehicle light cluster system (Safety Light Marker System) in form of elongated light sources located along the (3) on (2) (3) of a motor vehicle and connected to the motor vehicle signaling and electrical circuit in known ways. The Safety Light Marker System is operated to provide braking, parking emergency flasher and turn indications that will be clearly visible from the side and from above a motor vehicle and which significantly improve driving safety by improving the visibility of the motor vehicle.

There is a need, however, for an illuminated hazard warning light that is easily and universally recognized by drivers as a hazard warning light, easily connects to a vehicle's electrical system, is mounted on the vehicle itself, and can provide, if needed, a locating device for locating the vehicle with an emergency.

### OBJECTS AND SUMMARY OF THE INVENTION

It is an object of the present invention to provide an illuminated hazard warning light that can be universally recognized by drivers to warn them of a vehicle stopped on the side of the road or in an emergency.

It is a further object of the present invention to provide an illuminated hazard warning light that has a substantially flat hollow triangular casing, a plurality of light emitting diodes housed within the hollow triangular casing, and a connection device, electrically connecting the plurality of diodes to an electrical power source.

It is yet a further object of the present invention to provide an illuminated hazard warning light for heavy duty operation. The illuminated hazard warning light would include an illuminated hazard warning light, with a substantially flat hollow triangular casing formed of a clear, flexible adhesive material, a plurality of light emitting diodes housed within the hollow triangular casing, a switch, electrically connecting the plurality of diodes to an electrical power source, and an aluminum frame, whereby the substantially flat hollow casing is mounted within the aluminum frame.

In accordance with a first aspect of the present invention, a novel illuminated hazard warning light is provided. The illuminated hazard warning light includes a substantially flat hollow triangular casing, a plurality of light emitting diodes housed within the hollow triangular casing, and a connection device, electrically connecting the plurality of diodes to an electrical power source.

In accordance with another aspect of the present invention, a heavy duty illuminated hazard warning light is provided. The heavy duty hazard warning light includes an illuminated hazard warning light, with a substantially flat hollow triangular casing formed of a clear, flexible adhesive material, a plurality of light emitting diodes housed within the hollow triangular casing, a switch, electrically connecting the plurality of diodes to an electrical power source, and an aluminum frame, whereby the substantially flat hollow casing is mounted within the aluminum frame.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of an illuminated hazard warning light in accordance with the present invention.

FIG. 2A is a perspective view of the illuminated hazard warning light of FIG. 1 shown mounted on the inside of a rear windshield of a vehicle.

FIG. 2B is a perspective view of the illuminated hazard warning light of FIG. 1 shown mounted on the exterior of a vehicle.

FIG. 3 is an electrical schematic of a typical illuminated hazard warning light in accordance with the present invention.

FIG. 4 is a perspective view of an alternative embodiment of an illuminated hazard warning light shown mounted on a vehicle, in accordance with the present invention.

### DETAILED DESCRIPTION OF THE PREFERRED EMBODIMENT

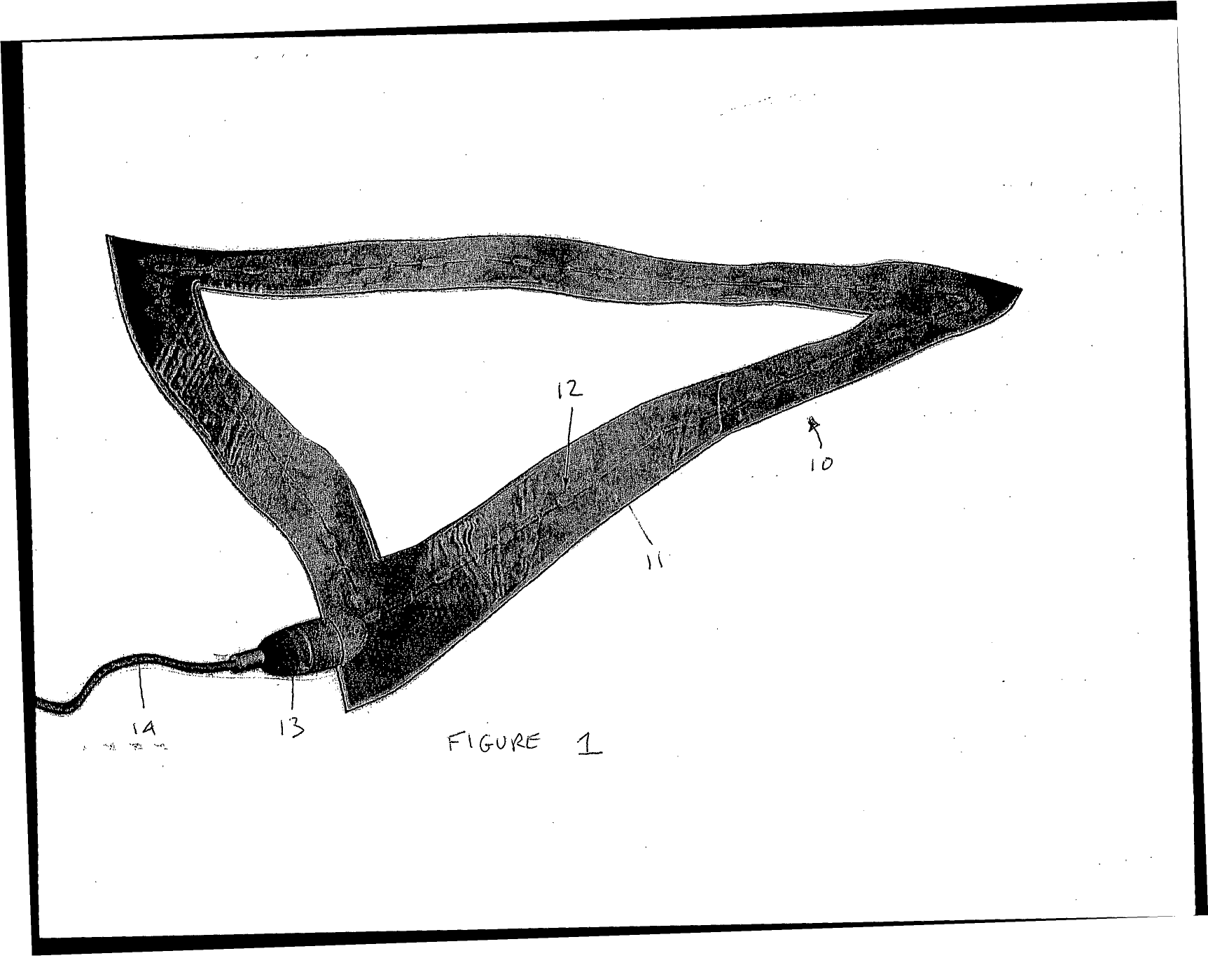

Referring now to the drawings, wherein like reference numerals refer to the same components across the several views, and in particular to FIG. 1, there is shown an illuminated hazard warning light 10. The illuminated hazard warning light 10 includes a substantially flat hollow portion 11, a connector 13, and a wire 14.

The substantially flat hollow portion 11 is formed in the shape of a triangle so that it can easily be recognized as a universal symbol cautioning oncoming drivers. Additionally, the substantially flat hollow portion 11 contains light emitting diodes 12 generally equally spaced within the substantially flat hollow portion 11 to provide illumination of the illuminated hazard warning light 10 when in use. In a preferred embodiment of the present invention, the substantially flat hollow portion 11 is formed preferably of a clear flexible material such as plastic, however, any suitable material known to one of ordinary skill in the art may be utilized to form the substantially flat hollow portion 11.

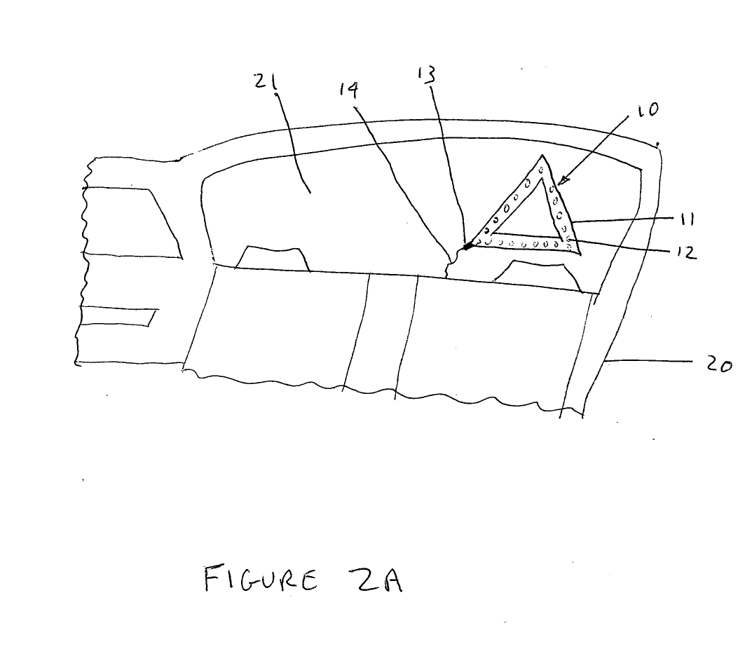

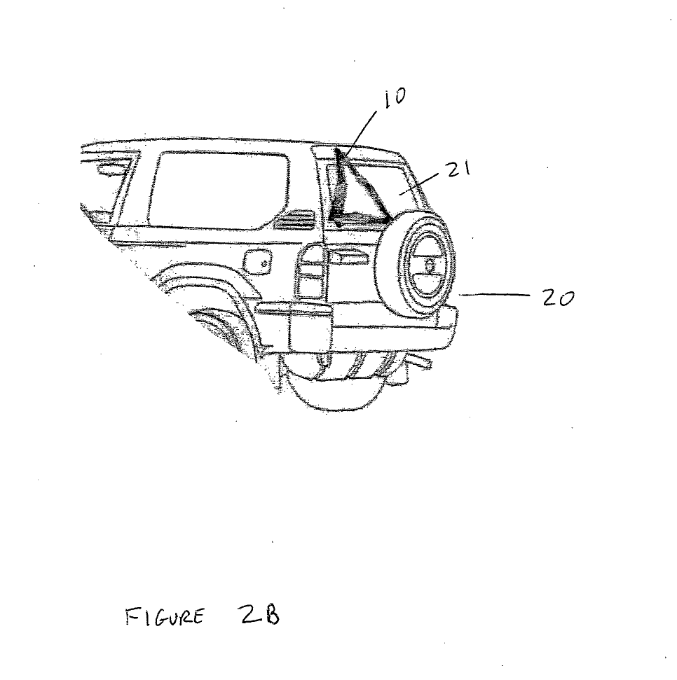

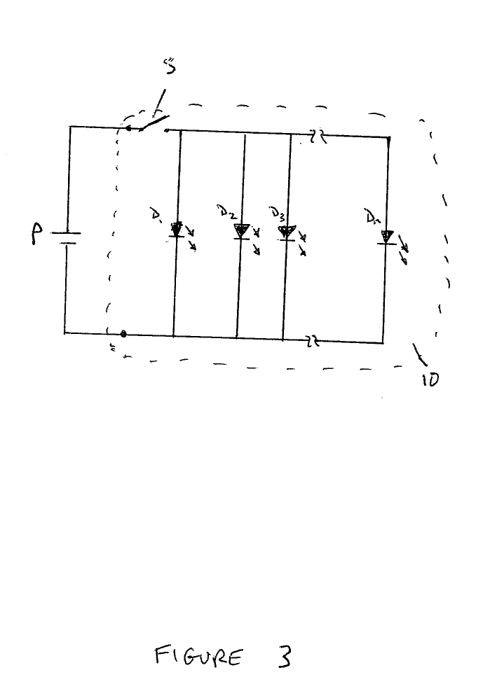

As can be seen in FIGS. 2A and 2B, the illuminated hazard warning light 10 is mounted on a vehicle 20, preferably on the rear window 21. A wire 14 connects the illuminated hazard warning light 10 to an electrical power source ‘P’, shown in FIG. 3. In FIG. 2A, the illuminated hazard warning light 10 is mounted on the inside of rear window 21. In FIG. 2B, the illuminated hazard warning light 10 is mounted on the outside of rear window 21, with the wire 14 running from the outside of the vehicle 20 to the inside. The substantially flat hollow portion 11 in a preferred embodiment of the present invention will be adhesive so as to facilitate mounting on rear window 21 of the vehicle 20. In this configuration, the illuminated hazard warning light 10 is in a position to be easily spotted by oncoming motorists to prevent them from colliding with the vehicle 20 that is stopped on the road.

The substantially flat hollow portion 11 may be formed directly of an adhesive material that adheres on contact due to static electricity, suction, friction, or other methods know to one of ordinary skill in the art. An actual adhesive may also be placed on the substantially flat hollow portion 11 to adhere it to the window 21. In this configuration, a film will be placed on the substantially flat hollow portion 11 that can be removed so as to expose the adhesive.

Referring now to FIGS. 1 and 3, the light emitting diodes 12 are connected to the electrical power source ‘P’, via a connector 13 and the wire 14. The light emitting diodes 12 are represented as D1, D2, D3, up to Dn. In a preferred embodiment, the Light emitting diodes 12 are electrically connected in parallel to one another with reference to the electrical power source ‘P’. In this way, if one LED 12 were to fail, the rest of the light emitting diodes 12 would remain lit. However, it can be readily seen by one of ordinary skill in the art that a number of ways of electrically connecting the light emitting diodes 12 may be employed. For example, the light emitting diodes 12 may be connected in series if so desired, or some combination of series and parallel connections. A switch ‘S’ is connected in series with the light emitting diodes 12 in order to electrically connect the light emitting diodes 12 to the electrical power source ‘P’.

The illuminated hazard warning light 10 may be directly wired to the vehicle's electrical system, represented by the electrical power source ‘P’. In this configuration, the switch ‘S’ would be a manual control switch that would be within easy reach of the driver to turn the illuminated hazard warning light 10 on and off by connecting the light emitting diodes 12 to the electrical power source ‘P’ as needed. In an alternate configuration, the switch ‘S’ may be a cigarette lighter adapter, which can be plugged into a cigarette lighter in order to power the light emitting diodes 12 and illuminate the illuminated hazard warning light 10.

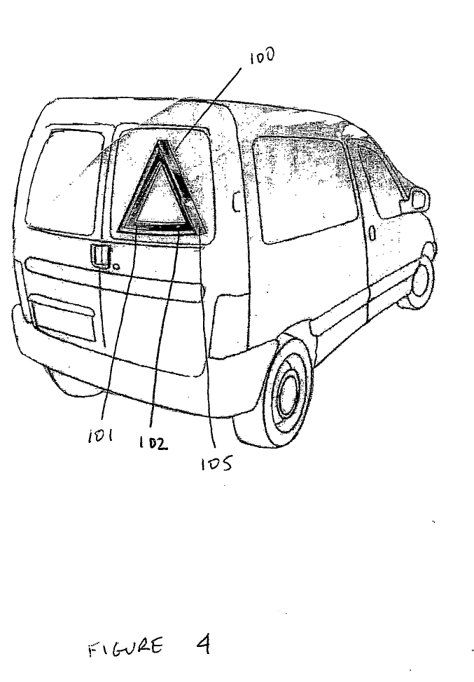

Referring now to FIG. 4, an alternative embodiment of an illuminated hazard warning light is shown as illuminated hazard warning light 100. The illuminated hazard warning light 100 is substantially similar to the illuminated hazard warning light 10. The illuminated hazard warning light 100 includes a substantially flat hollow portion 101 that is formed in the shape of a triangle so that it can easily be recognized as a universal symbol cautioning oncoming drivers. Additionally, the substantially flat hollow portion 101 contains light emitting diodes 102 generally equally spaced within the substantially flat hollow portion 101 to provide illumination of the illuminated hazard warning light 100 when in use. In a preferred embodiment of the present invention, the substantially flat hollow portion 101 is formed preferably of a clear flexible material such as plastic, however, any suitable material known to one of ordinary skill in the art may be utilized to form the substantially flat hollow portion 101.

The substantially flat hollow portion 101 of the illuminated hazard warning light 100 is mounted within a frame 105. The frame 105 can be mounted on a vehicle 200, such as a Heavy Goods Vehicle (HGV) by any means known to one of ordinary skill in the art. However, in a preferred embodiment of the present invention, the frame 105 is mounted to the vehicle 200 by means of screws or bolts. However, additional methods, such as riveting or welding the frame 105 to the vehicle 200 can be seen by one of ordinary skill in the art to accomplish the necessary purpose of mounting the frame 105 to the vehicle 200.

Either the illuminated hazard warning light 10 or 100 may further include a global positioning system (GPS) transmitter to allow the vehicles 20 or 200, respectively, to be located on the road when broken down. The GPS may be electrically connected in series with the switch ‘S’ so that when the illuminated hazard warning light 10 or 100 is switched on, the GPS will transmit the location of the vehicle 20 or 200 to facilitate aid in arriving. In this configuration, the GPS transmitter may be wired to the electrical power source ‘P’ of the vehicle 20 or 200. However, additional methods of powering the GPS transmitter can readily to be seen by one of ordinary skill in the art. For instance, the GPS transmitter may include it's own power supply, such as a battery.

In view of the foregoing disclosure, some of the advantages of the present invention can be seen. For instance, a novel illuminated hazard warning light is disclosed. The illuminated hazard warning light mounts directly onto a vehicle and is in the shape of a triangle, the universally recognized symbol for a hazard. This makes it much easier to see by an approaching motorist than current forms of warnings. Additionally, the light utilized by light emitting diodes is far less than by other sources of illumination.

While the preferred embodiments of the present invention have been described and illustrated, modifications may be made by one of ordinary skill in the art without departing from the scope and spirit of the invention as defined in the appended claims.

1. An illuminated hazard warning light, comprising:
a substantially flat hollow triangular casing;
a plurality of light emitting diodes housed within the hollow triangular casing; and
a connection device, electrically connecting the plurality of diodes to an electrical power source.

2. The illuminated hazard warning light of claim 1, wherein the substantially flat hollow triangular casing is formed of a clear flexible material.

3. The illuminated hazard warning light of claim 2, wherein the substantially flat hollow triangular casing is adhesive.

4. The illuminated hazard warning light of claim 2, further comprising an adhesive layer disposed on the substantially flat hollow triangular casing, and a removable film layer disposed on the adhesive layer such that when the removable film layer is removed, the adhesive layer is exposed.

5. The illuminated hazard warning light of claim 1, wherein the connection device is a switch connecting the plurality of light emitting diodes to the electrical power source.

6. The illuminated hazard warning light of claim 1, wherein the connection device is a cigarette lighter adapter for connecting the plurality of diodes to a cigarette lighter in a vehicle.

7. The illuminated hazard warning light of claim 1, further comprising a frame, whereby the substantially flat hollow casing is mounted within the frame.

8. The illuminated hazard warning light of claim 7, wherein the frame is formed of aluminum.

9. The illuminated hazard warning light of claim 1, further comprising a location tracking device.

10. The illuminated hazard warning light of claim 9, wherein the location tracking device is a global positioning system device.

11. The illuminated hazard warning light of claim 1, wherein the plurality of light emitting diodes are electrically connected in parallel to the power source.

12. The illuminated hazard warning light of claim 1, wherein the plurality of light emitting diodes are electrically connected in series with the power source.

13. An illuminated hazard warning light, comprising:
a substantially flat hollow triangular casing formed of a clear, flexible adhesive material;
a plurality of light emitting diodes housed within the hollow triangular casing;
a switch, electrically connecting the plurality of diodes to an electrical power source; and
an aluminum frame, whereby the substantially flat hollow casing is mounted within the aluminum frame.

14. An illuminated hazard warning light, comprising:
a substantially flat hollow triangular casing formed of a clear, flexible adhesive material;
a plurality of light emitting diodes housed within the hollow triangular casing;
a global positioning system, for providing location tracking of a vehicle;
a switch, electrically connecting the plurality of diodes and the global positioning system to an electrical power source; and
an aluminum frame, whereby the substantially flat hollow casing is mounted within the aluminum frame.
